(19) United States
(12) Patent Application Publication
(10) Pub. No.: US 2024/0253335 A1
(43) Pub. Date: Aug. 1, 2024

(54) RECYCLABLE PAPER PACKAGING LAMINATE HAVING A THIN BARRIER FILM AND GOOD TEAR-OPEN PROPERTIES

(71) Applicant: Constantia Pirk GmbH & Co. KG, Pirk (DE)

(72) Inventors: Frank Eger, München (DE); Andreas Fischer, Kohlberg (DE); Werner Geitner, Weiden (DE); Tobias Stein, Weiden (DE); Achim Grefenstein, Altrip (DE); Matthias Scheck, Waldthum (DE)

(21) Appl. No.: 18/566,512

(22) PCT Filed: May 31, 2022
(86) PCT No.: PCT/EP2022/064681

§ 371 Date: Dec. 1, 2023

(30) Foreign Application Priority Data
Jun. 2, 2021 (AT) A50451/2021

(51) Int. Cl. B32B 27/10; B32B 7/12; B32B 37/12; B65D 75/26

(52) U.S. Cl. CPC B32B 27/10; B32B 7/12; B32B 37/12; B65D 75/26; B32B 2250/02; B32B 2255/10; B32B 2255/205; B32B 2255/26; B32B 2307/516; B32B 2307/518; B32B 2307/582; B32B 2307/718; B32B 2307/7244; B32B 2307/7246; B32B 2307/7376; B32B 2317/12; B32B 2439/06; B32B 2439/70

(57) ABSTRACT

A packaging laminate includes a carrier layer and a barrier film, wherein the carrier layer consists of paper with a grammage of 40 to 120 g/m², wherein the barrier film is connected with the carrier layer via a connecting layer, wherein a plastics film stretched in at least one stretching direction is provided as the barrier film, wherein the barrier film has a layer thickness of 1 to 10 μm, preferably less than 5 μm and very preferably less than 3 μm, and wherein the elongation at break of the barrier film in the at least one stretching direction is less than or equal to 180%, preferably less than or equal to 130%.

### CROSS REFERENCES

The application is a U.S. National Stage Application of International Application No. PCT/EP2022/064681, filed May 31, 2022, which claims the benefit of priority based on Austrian Patent Application No. A50451/2021, filed on Jun. 2, 2021, the disclosures of each of which are hereby expressly incorporated by reference herein in their entireties.

### TECHNICAL FIELD

The present disclosure relates to packaging laminates.

### BACKGROUND

Plastic packaging laminates are nowadays provided for a wide range of packagings in different areas. Nevertheless, the long environmental resistance of most materials causes fundamental environmental problems. This fact is known to both the legislative bodies and to consumers. There are several legislative initiatives at national and supranational level. In Austria, the amendment to the Waste Management Act with effect from Jan. 1, 2020 can be mentioned as an example. Therein, so-called “plastic bags” have been banned from use in trade and commerce.

However, due to increased environmental awareness, the average consumer is also reluctant to purchase packaging materials that are exclusively produced from non-recyclable materials. Accordingly, there is a trend toward the production of alternative packaging materials, such as those based on bioplastics like polyhydroxybutyral or polylactides. Likewise, paper-based packaging is becoming increasingly popular, for example for food deliveries, chips or also for closure panels of a wide variety of packaging.

In general, all packaging must meet a certain minimum standard to ensure the freshness and durability of the packaged goods. In the case of most conventional plastics, but also metallic packaging, for example aluminum beverage capsules, the barrier properties were mostly present due to the impermeability of the materials to aromas, gas and liquids. New environmentally friendly materials usually have poorer barrier properties and therefore often need to be modified or coated to comply with the barrier properties required for packaging materials.

Specific transfer rates for characteristic substances are often specified as characteristic values for the barrier properties. The oxygen transfer rate (OTR) due to the oxidation of food is particularly relevant, as is the water vapor transfer rate (WVTR) with regard to microbial contamination. Often, fat transfer rates and also the aroma barrier properties are also important.

Therefore, the principal objective is to provide environmentally sound packaging materials that comply with the necessary barrier properties and, preferably, are also recyclable.

One possible method for evaluating the recyclability of paper-containing packaging laminates is the so-called PTS-RH 021/97 method. Particular attention must be paid here to the defibering behavior and sticky formation. Sticky formation is understood by the person skilled in the art as the deposition of sticky impurities during recycling. Due to heat-sealing lacquers, adhesives, etc., sticky components can form during sheet formation and subsequent drying during paper production and are undesirable. To determine the defibering behavior, the paper-containing packaging is defibered using a laboratory pulper. After this defibering process, the material is fractionated. In this case, isolated fibers and fillers can be fractionated by a slotted or perforated plate. The remaining “coarse reject”, for example plastic parts and the like, is considered a non-paper component that cannot be recycled. If this proportion is less than 20%, the packaging laminate is said to be recyclable and to contain paper.

EP 1 083 043 B1 discloses a packaging laminate for ice cream packaging, such as cone-shaped cones, with a layer of polypropylene (PP), polyethylene (PE) or polyamide (PA) with layer thicknesses of 6-25 μm and parchment, glassine or parchment substitute paper with areal weights of 60-110 g/m². What is specific to these packagings is that they must be fat-repellent and moisture-repellent. Recyclability is not addressed in the disclosure.

EP 3 784 486 A1 discloses a packaging laminate made of a glassine/PET with layer thicknesses of the PET of 5-70 μm, used with additional special barrier layers or sealing layers for a board. Metal or metal oxide layers are dispensed with in order to improve biodegradability.

JP 6635355 B2 discloses a packaging laminate made of polyolefins partially from non-fossil origin and paper as a carrier layer. The polyolefin layer is extruded directly onto the paper. The laminate has a thickness of 10-100 μm in total. Due to the fact that the polyolefin is extruded onto the paper, subsequent separation is hardly possible. This means that the material is not recyclable.

These packaging laminates generally have the problem that the tear-through properties are dominated by the plastic film, and as a result tear propagation of the packaging is not easily possible, or the plastic film or coating can be stretched to such an extent that undesirable plastic particles can contaminate the food. It can also cause problems when unpacking packaged goods with paper as the carrier material, as the plastic film prevents tear propagation due to its high elongation at break. Furthermore, it is then directly apparent to the consumer that plastic is present in packaging.

The object of the present disclosure is to provide a packaging laminate which has sufficient barrier properties and the tearing properties of paper, but is still recyclable.

### SUMMARY

According to the present disclosure, this is achieved by providing an unusually thin plastic film stretched in at least one stretching direction as a barrier film, wherein the barrier film has a layer thickness of 1 to 10 μm, preferably less than 5 μm and very preferably less than 3 μm, and wherein the elongation at break of the barrier film in the stretching direction is less than or equal to 180% and preferably less than or equal to 130%.

Accordingly, within the scope of the present disclosure, it is possible to stretch the barrier film in a first stretching direction. It is also possible to stretch the barrier film in a second stretching direction. The barrier film can be stretched exclusively in a first stretching direction or exclusively in a second stretching direction. However, the barrier film can also be stretched in a first stretching direction and in a second stretching direction. Stretching in both a first and a second stretching direction is usually referred to as biaxial or bidirectional stretching. If the barrier film is stretched in two stretching directions, then the elongation at break of the barrier film is advantageously less than or equal to 180% in both stretching directions, preferably less than or equal to 130%.

Due to the high rigidity and low elongation at break of the barrier film, the entire packaging laminate surprisingly takes on the tear resistance of the paper. This is advantageous for the removal or unpacking of the filling material and makes it possible to provide paper packaging with high barrier properties for the consumer. Nevertheless, the plastic does not influence the tear resistance of the packaging laminate. Preferably, the consumer also does not notice that a small proportion of plastic is present in the packaging due to the paper-like tearing properties.

The packaging laminate according to the present disclosure consists of a carrier layer of paper and a barrier film, which consists of a plastic film made of thermoplastics, such as polyolefins or polyesters. The carrier layer consists of paper of any type and is constructed of material consisting of cellulose, hemicellulose and/or lignin-containing material, with the exception of glassine. Although both glassine and paper are derived from cellulose, glassine is structurally fundamentally different from paper because the types of pulp milling used in producing glassine and paper are different. Paper can be produced, for example, from pulp, wood pulp or waste paper pulp, or even agricultural waste such as silphia, grass, straw, and the like. The carrier layer has a grammage of 40-120 g/m².

In an advantageous embodiment, the carrier layer consists of uncoated paper. Uncoated paper includes all wood-free or wood-containing papers that are produced without synthetic ingredients. Its surface usually reveals fine fibers, is somewhat rougher and open-pored. Preferably, uncoated paper with a grammage between 40 and 120 g/m² is used.

Advantageous thermoplastics can be, for example, polyolefins, such as polyethylene (PE) in various types such as high density PE (HDPE) or low density PE (LDPE), polypropylene (PP) as a homopolymer, polybutylene (PB), polyisobutylene (PIB) and the like, which are considered suitable in the field of packaging laminates by a person skilled in the art.

Preferably, other thermoplastics, such as polyester, in particular polyethylene terephthalate (PET), can also be used for packaging laminate according to the present disclosure.

PP homopolymer can be produced by different methods and have different orientations of chain radicals. Advantageously, for such packaging laminates oPP can be used, which is produced via polymerization using Ziegler-Natta catalysts.

The elongation at break of the plastics is determined by a tensile test. The tensile test is subjected to the standard ISO 527 or ASTM D882-12. The elongation at break in %, and optionally also the tensile strength in N/mm², of the barrier film is measured. The tensile test is performed as follows: the prepared sample of the barrier film (100×15 mm) is subjected to a tensile force on the tensile machine until fracture. The sample is clamped in the tensile tester in such a way that the longitudinal axis of the sample coincides with the line of action of the tensile force. The zero point position of the tensile force and the displacement must be checked and ascertained before starting the tensile test. The required strain rate is set to 50 mm/min. The specimen strain is taken over the displacement measuring range of the tensile tester. For use in a packaging material according to the present disclosure, the barrier film should have an elongation at break of less than/equal to 180% and preferably less than/equal to 130% in the desired thickness range of 1 to 10 μm.

More preferably, the barrier film may be optically transparent or partially transparent. The term “transparent” means that the material exhibits no or hardly any absorption in the visible range of the electromagnetic spectrum. This can be achieved, for example, via a plastics film containing partially transparent PP, such as cast PP, axially oriented PP, amorphous or crystalline PP. Atactic and isotactic PP are also conceivable. PET can also be processed amorphously and is thus present as a transparent material, as is known for beverage bottles. The layer thickness of the plastics film can also influence the transparency. This enables the packaging laminate to take on the color of the paper. Further, it can be advantageous for a wide variety of prints on the carrier layer or the barrier film.

To produce the elongation at break according to the present disclosure, the barrier film is stretched in at least one direction. Stretching is understood to mean the deformation of the plastics film in one direction, such as longitudinal deformation in the machine direction (MD) or deformation normal to the machine direction (“transversal direction”, TD), both beyond the elastic yield point. The machine direction can correspond to a first stretching direction and the transverse direction to a second stretching direction. As a result, the plastic fibers arrange themselves in the direction of longitudinal deformation and thus obtain, among other things, the desired elongation at break properties. It is also conceivable for the barrier film to be stretched biaxially, i.e., in both directions. This can be advantageous if the barrier film is to obtain a desired anisotropy, for example to be more tearable in a preferred direction.

Optical transparency can also be advantageous in meeting consumer demand for sustainable packaging. Paper is generally perceived as natural or sustainable, while plastic is often considered environmentally harmful. A thin plastics film, as in the barrier film according to the present disclosure, can allow the feel of the paper to be retained and offers a further number of advantages, such as increased puncture resistance and improved barrier properties compared with paper-only packaging. According to the present disclosure, the tear properties, such as tearing resistance, should be as close as possible to those of paper-only packaging, so that the feel of the composite laminate and the behavior on tearing correspond to that of paper-only packaging.

The polymer in the barrier film may itself already have good barrier properties against oxygen, water vapor, fat, carbon dioxide, aromatic and saturated mineral oil components and aroma. Polymer films act like diffusion membranes, especially for apolar substances and can be described according to the solution-diffusion model for individual substance groups. Depending on the substance group, the barrier effect can therefore vary. To ensure that substances that are readily permeable to the plastics film have a barrier effect, an additional barrier layer can be applied to the barrier film. Preferably, barrier layers may consist of metals or semimetals or oxides. Metals can be applied in thin layers, for example via sputtering, so-called cathode sputtering. In this case, a voltage is applied between a metal cathode and an anode ring and a plasma is ignited, which removes metal atoms from the cathode and these settle on a substrate.

Physical or chemical vapor deposition are also conceivable. Physical vapor deposition is similar to sputtering, but can also be processed via electric arcs and lasers, for example. Chemical vapor deposition can use precursors that react in the chamber to form a thin film. AlOₓ and SiOₓ, for example, can be applied as pure metals and then form an oxide layer or can be applied chemically by means of suitable precursors.

However, barrier layers made of plastics are also conceivable. Preferably, polyamide (PA) or ethylene-vinyl alcohol copolymer (EVOH) are used. These can be applied as a lacquer coating. However, it is also conceivable and usually more economical for the plastics film to be co-extruded together with the barrier layer. Preferably, the known blown film or flat film extrusion process is used.

The barrier layer can additionally also be coated with a protective lacquer, especially to protect against microcracking, which can impair the barrier function. With such a barrier layer, low OTR and low WVTR can also be achieved. In addition, the carrier layer can also be provided with a barrier layer, a carrier barrier coating. Different barrier layers can be advantageous in order to achieve a desired value of a specific transfer rate. Depending on the barrier layer, the thickness varies and can be between 0.01 and 1 μm.

Both components, i.e., carrier layer and barrier film, can be designed such that they can be easily separated from one another. This can be important during a recycling pulp process so that the barrier film is separated and fed to a separate recycling process. The carrier layer of paper can then be reused as waste paper after reprocessing.

The barrier film is connected to the carrier layer by means of a connecting layer. The connecting layer is preferably a wet-applied laminating adhesive. Laminating adhesives refer to adhesives which are applied wet to a layer by means of a roller and which ensure sufficient bond adhesion between two layers in a packaging laminate. A laminating adhesive may be hydrophilic, causing the bonds of the adhesive, such as hydrogen bonds, to weaken and the layers to separate upon contact with moisture or water. Likewise, it may also be possible for the laminating adhesive itself to be water-soluble, such as, for example, starch-based or protein-based laminating adhesive. Such a laminating adhesive can be advantageous in the recycling process because the polymer components of the barrier film can be easily detached from the paper. Such a laminating adhesive may preferably have an application weight in the dried state of 0.5 to 5 g/m². However, a laminating adhesive can also be hydrophobic and ensure strong bond adhesion in moist environments.

The layer thickness of the packaging laminate can be in the range of 40 to 130 g/m² or about 40 to 130 μm, the barrier film can preferably be used in a range of 1-10 μm and more preferably in a range of less than 5 μm, very preferably in a range of less than 3 μm.

When recycling the packaging laminate, it is, usually after mechanical shredding, soaked in water at a specific water temperature and for a specific time (pulp process). Due to the properties of the packaging laminate according to the present disclosure, the carrier layer can detach from the barrier film during the pulp process when recycling, together with all layers and potential impurities for the paper recycling. A hydrophilic or water-soluble connecting layer reacts with the water during the pulp process and loses its adhesive properties or dissolves completely in water so that the carrier layer is separated from the barrier film. The carrier layer can thus dissolve in the water and form a pulp from which in turn recycled paper can be produced. For the recycling of the packaging laminate, it is advantageous if the carrier layer loses its adhesion in a sufficient manner or dissolves at a water temperature of 40° C. within a maximum of 20 minutes, preferably a maximum of 10 minutes, particularly preferably a maximum of 5 minutes, so that the carrier layer and the barrier film easily separate.

Since the barrier layer (if provided) can remain on the detached barrier film after separation during the pulp process in paper recycling, the recycled paper does not turn gray, which would inevitably occur especially in the case of a barrier metallization of a paper surface.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 shows a packaging laminate with a barrier film according to an embodiment of the present disclosure,

FIG. 2 shows a packaging laminate with a barrier layer according to another embodiment of the present disclosure,

FIG. 3 shows packaging with a packaging laminate according to another embodiment of the present disclosure,

FIG. 4 shows bag packaging with a packaging laminate according to another embodiment of the present disclosure,

FIG. 5a shows a stress-strain diagram of a packaging laminate according to another embodiment of the present disclosure,

FIG. 5b shows a stress-strain diagram of an exemplary prior art packaging laminate,

FIG. 6a shows crack patterns of a packaging laminate according to an embodiment of the present disclosure, and

FIG. 6b shows crack patterns of an exemplary prior art packaging laminate.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

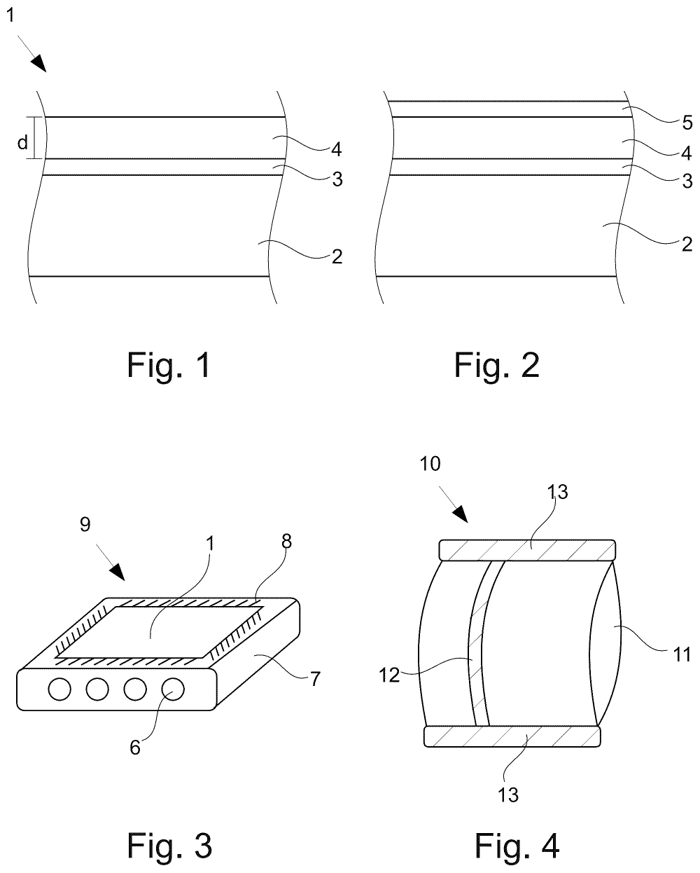

FIG. 1 shows a packaging laminate 1 according to the present disclosure. The packaging laminate 1 basically consists of a carrier layer 2 and a barrier film 4. The barrier film 4 is a plastics film and a barrier layer 5 can additionally be applied. The carrier layer 2 is connected to the barrier film 4 by means of a connecting layer 3.

The carrier layer 2 is made of paper. Paper is understood to mean any design of material which consists of cellulose, hemicellulose or lignin-containing material, with the exception of glassine. Glassine, while made from cellulose, is structurally fundamentally different from paper because the respective types of pulp milling used in producing glassine and paper are different. Paper can be produced, for example, from pulp, wood pulp, or waste paper pulp (or mixtures thereof). The paper used may be a food contact paper and coated or uncoated. Preferably, the paper is untreated on both sides with no extraneous content, and thus is a so-called uncoated paper, that is, for example, without layers of polymers as is the case with commercially available coated paper. However, the paper of the carrier layer 2 may also have a coating, usually of a polymer. The carrier layer 2 can, for example, itself have sufficient barrier properties against water vapor and oxygen.

It is also possible for the carrier layer 2 to additionally be provided with a carrier barrier coating. The carrier barrier coating may in this case comprise at least one polymer selected from a group which at least comprises one polyvinyl alcohol, which is preferably present as a homo- or co-polymer, PVDC, biopolymers, polyester, casein, starch, thermoplastic starch, sugar, cellulose, carboxymethyl cellulose, cellulose ether, xanthan, carrageenan, polypeptides, proteins, gelatin, pectin, guaran, chitin derivatives, chitosan derivatives (in particular N-carboxymethyl chitosan), dextran, gluten, hyaluronic acid, polyhydroxyalkanoate-based water-soluble polymer, ionomers, polyurethane, an ethylene-vinyl laurate-alcohol copolymer, one or more copolymers of a polyester and aliphatic epoxides, one or more copolymers of an (alkylated/arylated) acrylate and aliphatic epoxides, one or more homo- or co-polymers of polyvinylpyrolidone, one or more cycloolefin copolymers (COC), in particular preferably based on norbornene polymers (COP) and preferably based on norbornene-ethylene copolymers (COC), (partially or completely hydrogenated), polyamides, cellulose derivatives, one or more soluble polycarbonate copolymers individually or in a combination of several of the polymers contained in the group and preferably a crosslinking component from the group of isocyanates, amines, anhydrides, oxazolines, azeridines, reactive silanes, di-carboxylic acids.

In the case where the carrier layer 2 has a carrier barrier coating, the carrier barrier coating may be provided on the side of the carrier layer 2 facing the connecting layer 3. However, the carrier barrier coating can also be provided on the side of the carrier layer 2 facing away from the connecting layer 3. Likewise, it is possible to provide a carrier barrier coating both on the side of the carrier layer 2 facing the connecting layer 3 and on the side of the carrier layer 2 facing away from the connecting layer 3.

According to the present disclosure, the carrier layer 2 has a grammage of 40 to 120 g/m² and is thus substantially thicker than the barrier film 4, as indicated in FIG. 1. The packaging laminate 1 is therefore designed asymmetrically.

The barrier film 4 can be a thermoplastic, in particular polyolefins or polyesters. In a preferred embodiment, the barrier film consists of polyproplylene (PP) in the form of a homopolymer, high-density polyethylene (HDPE), ethylene-vinyl alcohol copolymer (EVOH), or polyester, such as polyethylene terephthalate (PET). The barrier film 4 is stretched in at least one direction. The barrier film 4 can preferably also be biaxially stretched in order to produce comparable elongation at break properties in both film directions. Stretching is understood to mean longitudinal deformation in the machine direction (MD), and in the case of bidirectional stretching also in the transversal direction (TD) normal to the machine direction, beyond the elastic yield point. This causes the plastic fibers to arrange themselves in the direction of the longitudinal deformation and thus obtain, among other things, the desired elongation at break properties. These are determined by means of the tensile test according to standard ISO 527-1. Preferably, stretching is carried out with a stretching ratio in MD of 1:2 to 1:10 and in TD of 1:2 to 1:10.

By stretching, it is also possible to obtain increased barrier properties of the barrier film 4, compared to an unstretched plastics film. However, other properties of a plastics film, for example optical transparency, can also be influenced by stretching.

The carrier layer 2 and the barrier film 4 stretched in one direction are connected via a connecting layer 3. The connecting layer 3 can preferably be a laminating adhesive. Laminating adhesives may, for example, be hydrophilic and lose the bond upon contact with moisture, which may improve or facilitate recycling of the packaging laminate 1. Suitable polar connecting layers 3 preferably consist of polymers with increased polarity, for example based on maleic anhydride-grafted polyolefins (such as PE or PP), ethylene-vinyl acetate copolymer (EVA), ethylene/acrylic acid copolymer (EAA), ethylene-butyl acrylate copolymer (EBA), or similar polyolefin copolymers, or also polyurethane. Compostable and water-soluble materials such as starch- or protein-based adhesives are also conceivable. Preferably, the connecting layer 3 has an application weight in the dried state of 5-0.5 g/m², most preferably below 2.5 g/m².

In a preferred embodiment, a barrier layer 5 can be applied to the barrier film 4. Preferably, the barrier layer 5 may consist of a layer of a (semi)metal or (semi)metal oxide. In a preferred embodiment, the barrier layer 5 consists of AlOₓ, SiOₓ or a metallization, preferably with aluminum. The barrier layer 5 can be applied via chemical or physical vapor deposition (CVD or PVD), or preferably, in the case of metals, via cathode sputtering. In this case, the barrier layer 5 is applied to the barrier film 4 after stretching.

In a further possible embodiment, the barrier layer 5 is a layer of a barrier polymer, i.e., a polymer with sufficient barrier properties. The barrier polymer is preferably a polyamide (PA) or an ethylene vinyl alcohol copolymer (EVOH). EVOH is preferred as the barrier polymer. Such a barrier layer 5 can, for example, be co-extruded, extrusion laminated or laminated with the barrier film 4. In extrusion lamination or laminating, a suitable laminating adhesive is provided for connecting the barrier layer 5 and the barrier film 4.

In addition, a protective lacquer can be applied to the barrier layer 5, and can also additionally improve the barrier properties. In a preferred embodiment, the packaging laminate 1 consists of carrier layer 2, barrier film 4, barrier layer 5 and protective lacquer layer (although possible connecting layers are not mentioned).

The barrier layer 5 may, depending on the design and material, enhance barrier properties against water vapor, oxygen, aromatic and saturated mineral oil components, fat, carbon dioxide and/or aroma.

The barrier properties are preferably indicated in specific transfer rates. Uncoated plastics films have typical ranges for OTR of 40-60 cm³/(m²*d*bar) (where “d” stands for day) and typical ranges for WVTR of 260-500 cm³/(m²*d*bar). A barrier layer 5, such as a metallization, can significantly improve these properties. For oxygen, a preferred OTR less than 5 cm³/(m²*d*bar) (where “d” stands for day), very preferably less than 1.5 cm³/(m²*d*bar) can in that case be achievable. For water vapor transfer rate WVTR, a value of 5 cm³/(m²*d*bar) can preferably be achieved, and very preferably values less than 1 cm³/(m²*d*bar) for high-quality products. For aromatic and saturated mineral oil components less than 12 g/(m²×d) measured at 23° C. and 50% relative humidity (r. h). For grease resistance, a KIT value of 12 was determined, which was measured according to Tappi 559 (“Grease resistance test for paper and paperboard, Test Method T 559 cm-12”). The KIT value is divided into a scale of 1-12, with 12 representing the highest barrier effect. There is no objective measure for the aroma barrier, so that the effect as an aroma barrier is determined subjectively by odor tests.

It is also possible for the barrier properties to be satisfied only by a combination of carrier layer 2, barrier film 4 and barrier layer 5. For example, the carrier layer 2 can provide the necessary oxygen and water vapor barrier, while the barrier film 4 satisfies the necessary barrier properties for fat, mineral oil components and aroma.

According to the present disclosure, the barrier film 4 has a layer thickness d of 1 to 10 μm, preferably 5-1 μm. If polyolefins are used in the barrier film 4, very preferably less than 3 μm, and if PET is used, very preferably less than 5 μm.

A barrier layer 5 of the barrier film 4 can be arranged facing the connecting layer 3, as shown in FIG. 2. However, it is also conceivable for the barrier layer 5 to be arranged facing away from the connecting layer 3, i.e., on the outside when used in a package. A barrier layer 5 in packaging in the direction of the filling material 6 may also be particularly suitable for filling material which would attack the carrier layer 2, for example, such as acidic foodstuffs.

Depending on the intended application, bond adhesion between barrier film 4 and carrier layer 2 should be sufficiently high to prevent delamination of the packaging laminate 1. The bond strength is determined with a peel test. In a peel test, a test strip of the packaging laminate 1 is pulled apart at free ends of the carrier layer 2 and the barrier film 4. The free ends are clamped in a pulling machine and pulled apart at a predetermined pulling-off angle (e.g., 90°) and the force is thus measured. If the width of the test strip is 15 mm, the bond strength is given in N/15 mm. The level of the measured force is at least greater than 0.5 N/15 mm, preferably up to 3 N/15 mm, for sufficient bond adhesion. If the bond adhesion is very good, a paper fiber tear or a split in the plastics film or barrier layer 5 can also occur. In this case, the indication of the bond strength is the near-constant peel value and not the maximum tear value that is produced at the beginning of the peel test as a force peak. Typically, a number of peel tests are carried out in order to determine the bond strength and the bond strength sought is determined as an average value from the individual measurements. The peel test is carried out, for example, according to the ASTM F904 standard.

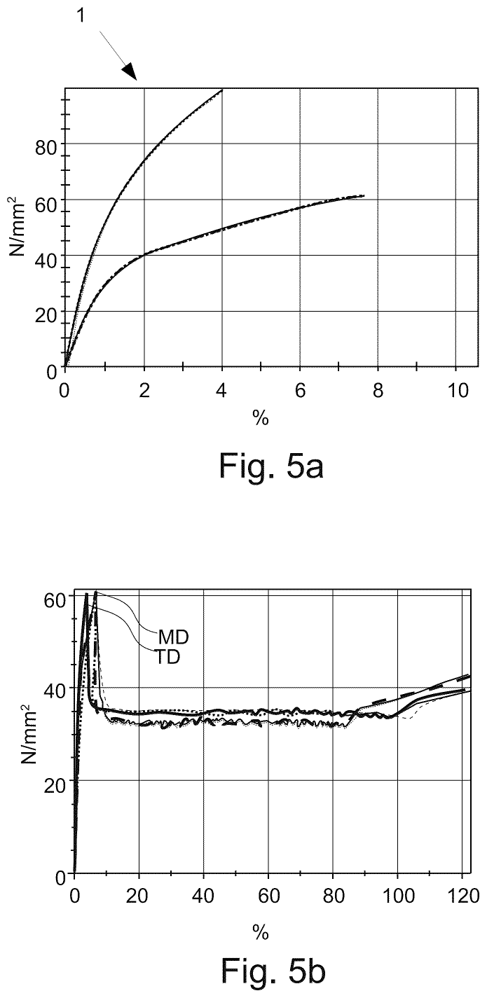

According to the present disclosure, the tear properties of the packaging laminate 1 are similar to the tear properties of paper-only packaging, but high barrier properties can be enabled by the barrier film 4, compared to paper-only packaging. The so-called tearing resistance of the packaging laminate 1 is determined by the elongation at break and influenced by the material used for the barrier film 4 and the layer thickness of the barrier film 4, optionally including the barrier layer 5. To achieve the tearing resistance according to the present disclosure, the elongation at break of the barrier film 4 in the stretching direction is less than or equal to 180%, preferably less than 130%. In the case of a bidirectionally stretched barrier film 4, thus in both stretching directions. By biaxially stretching the barrier film 4, the anisotropy with respect to the tearing resistance in the two stretching directions can be kept as low as possible. This enables tear properties of the laminate according to the present disclosure as shown in FIG. 5a.

In case of an additional barrier layer 5 and/or protective lacquer layer, the elongation at break of the barrier film 4 with the additional barrier layer 5 and/or protective lacquer layer should not exceed 180%. Very tough materials for the barrier layer 5 and/or protective lacquer layer may thus be unfavorable for the intended application.

Below follows a comparison of a packaging laminate 1 according to the present disclosure with a packaging laminate from the prior art.

The packaging laminate 1 according to the present disclosure is a 70 g/m² paper as a carrier layer 2, which was laminated by means of a laminating adhesive with a 4.5 μm thick PET film, as a barrier film 4. The laminating adhesive was applied with an areal weight of 1.5 g/m². FIG. 5a shows the stress-strain diagrams of the packaging laminate 1 according to the present disclosure. The PET film used in the packaging laminate 1 according to the present disclosure has an elongation at break of 95% in MD and 85% in TD and is usually used in these thicknesses in technical applications as a capacitor film.

The comparative example is a 42 g/m² paper, laminated as a carrier layer 2 against a 12 μm PET film, which is typical for packaging applications of all types. FIG. 5b shows the stress-strain diagrams of the comparative example. The PET film (PETLAIN from Superfilm) has an elongation at break of 140% in MD and 110% in TD. Thus, the barrier film 4 is within the elongation at break range according to the present disclosure, but outside the thickness range. This can cause problems when tearing packaging made from such a packaging laminate not according to the present disclosure (for example when unpacking packaged goods), since the plastics film in the barrier film 4 prevents easy tear propagation due to its high thickness. This can be problematic when opening packaging. Furthermore, this can make it directly apparent to the consumer that plastic is present in packaging, which is often to be avoided.

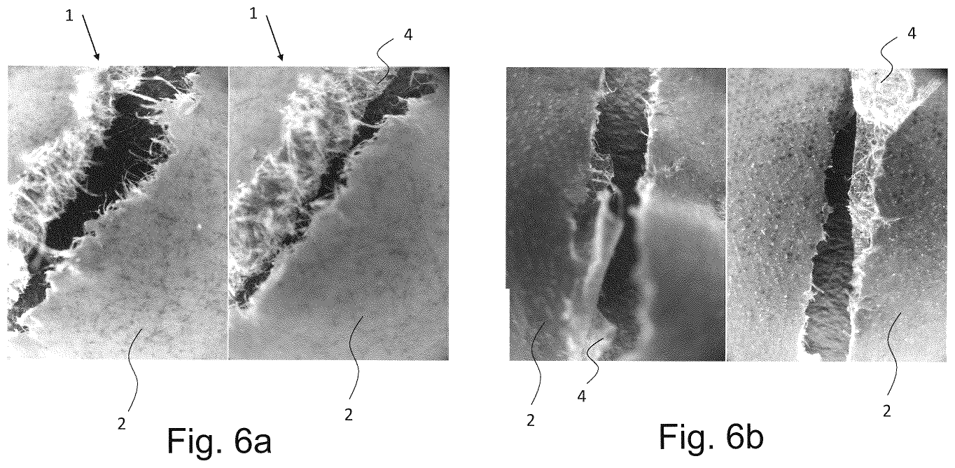

The tearing behavior can also be readily seen in the stress-strain diagram in FIG. 5a. The packaging laminate 1 according to the present disclosure tears at about 4% MD and about 6% TD. In the comparative example (FIG. 5b), the paper tear is present at similar yield strengths, after which only the PET film of the barrier film 4 is stretched, which is evident in the plastic deformation range of the stress-strain diagram, and is also noticeable in a visible barrier film 4 after tearing (FIG. 6b). Paper alone, with the exemplary grammage of 70 g/m², has an elongation at break of MD 2.8%, TD 4.5%.

Crack patterns of the packaging laminate 1 according to the present disclosure are illustrated in FIG. 6a. If the stress-strain diagrams are compared with the corresponding crack patterns (FIG. 6a) of the packaging laminate 1 according to the present disclosure, no separate plastic residue of the barrier film 4 can be seen in the crack pattern. This is consistent with the stress-strain diagram, where also only one crack area is visible, since the plastic of the barrier film 4 adapts to the cracking behavior of the paper of the carrier layer 2. The plastic of the barrier film 4 does not undergo stretching and is therefore not perceived by the consumer as disturbing when the packaging is torn open, nor can it be perceived as such. In contrast, the plastics film of the barrier film 4 is clearly visible below the paper of the carrier layer 2 in the crack pattern of the prior art (FIG. 6b). In both cases, the connecting layer 3 is not visible in the crack pattern due to the relatively thin layer thicknesses.

In a preferred embodiment, the packaging laminate 1 may be sealed to a packaging container 7 in the form of a closure panel via the barrier film 4 to produce packaging 9. For this purpose, it is necessary for the barrier film 4 to be oriented in the direction of the filling material 6. The packaging 9 is shown in FIG. 3. For this purpose, the closure panel is punched out of the packaging laminate 1 according to the present disclosure and sealed onto a sealing edge 8 of the packaging container 7 in a heat sealing method. Preferably, the sealing is performed at a sealing edge 8 of a packaging container 7, which achieves a tight connection between the packaging container 7 and the packaging laminate 1. The sealing temperature for conventional sealing layers 8 can be, for example, between 120° C. and 290° C., usually between 180° C. and 250° C., but attention must be paid to the heat resistance of the carrier layer 2 used.

The packaging 9 can be intended, for example, for fat-containing foodstuffs which are packaged in portion-ready form. In a preferred embodiment, such packaging 9 is suitable for portions of butter, hazelnut cream and also for jam or honey. Even liquid filling material is conceivable due to the high liquid-tightness. Of course, larger quantities of foodstuffs can also be packaged with packaging laminate 1 according to the present disclosure. This does not require sealing, as shown in FIG. 3. Such packaging 9 can, for example, be folded from a cutout of the packaging laminate 1 and fixed in place by means of an adhesive, preferably a pressure-sensitive adhesive. The packaging laminate 1 can be used, for example, for seasonal goods or fat-containing foodstuffs such as butter, cheese, etc. For this purpose, the carrier layer 2 of paper can either be arranged in the direction of the filling material or also in the direction of the surroundings.

The packaging laminate 1 according to the present disclosure can also be used for producing packaging in the form of a bag. For this purpose, the packaging laminate 1 can be cut to size and shaped into a bag 11, for example by folding, and sealed at overlapping points, as shown in FIG. 4 using the example of a bag 11 with a longitudinal seal 12 and two transverse seals 13. However, the packaging laminate 1 can also be processed directly in known continuous packaging machines, for example so-called form-fill machines or bag forming, filling and sealing machines. For sealing, the folded, overlapping packaging laminate 1 is known to be pressed together at the sealing point between two temperature-controlled sealing jaws. In all cases, sealing is performed on the sealing layer of the packaging laminate 1 formed by the barrier film 4, either against its own sealing layer or against the carrier layer 2.

The carrier layer 2 or the entire packaging laminate 1 can have an embossing. A pattern embossing may be implemented as a die embossing, linen embossing, line embossing, wave embossing, halftone embossing, dot embossing, needle embossing, damask embossing, image embossing, lettering embossing, Braille embossing or combinations thereof. Thus, on the one hand, inexpensive and already existing embossing calenders can be used, and on the other hand, embossing calenders specifically produced for the respective product can be used, with the pattern embossing giving the product a pleasing appearance in any case.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1. A packaging laminate consisting of
a carrier layer comprising paper with a grammage of 40 to 120 g/m²,
a barrier film connected with the carrier layer via a connecting layer, wherein the barrier film comprises a plastics film stretched in at least one stretching direction and wherein the barrier film has a layer thickness of about 1 to 10 μm, and
wherein an elongation at break of the barrier film the at least one stretching direction is less than or equal to 180%.

2. The packaging laminate according to claim 1, wherein the barrier film is stretched biaxially in a first stretching direction and in a second stretching direction.

3. The packaging laminate according to claim 2, wherein a first elongation at break of the barrier film in the first stretching direction is less than or equal to 180%, and wherein a second elongation at break of the barrier film in the second stretching direction is less than or equal to 180%.

4. The packaging laminate according to claim 1, wherein the barrier film comprises one of polypropylene homopolymer, polyethylene, EVOH copolymers, or polyethylene terephthalate.

5. The packaging laminate according to claim 1, further comprising a barrier layer on the barrier film, wherein the barrier layer is applied to the barrier film.

6. The packaging laminate according to claim 5, wherein the barrier layer comprises one of AlOₓ, SiOₓ, or a metallization, preferably of aluminum.

7. The packaging laminate according to claim 5, wherein the barrier layer comprises one of EVOH copolymers or polyamide.

8. The packaging laminate according to claim 5, wherein the barrier layer has a layer thickness of about 0.01 to 1 μm.

9. The packaging laminate according to claim 1, wherein carrier layer comprises uncoated paper.

10. The packaging laminate according to claim 9 wherein the carrier layer comprises a carrier barrier coating.

11. The packaging laminate according to claim 1, wherein an oxygen transfer rate is less than about 5 cm³/(m²*d*bar) and a water vapor transfer rate is less than about 5 cm³/(m²*d*bar).

12. A packaging having a packaging container, comprising a closure panel comprising the packaging laminate according to claim 1 is sealed to a sealing edge of the packaging container.

13. A packaging in the form of a bag, comprising a packaging laminate according to claim 1 wherein the packaging laminate is folded and sealed at overlapping points after folding.

14. A method for producing a packaging laminate, comprising the steps of:
providing a barrier film stretched in at least one stretching direction with a layer thickness of 1-10 μm, and with an elongation at break in the at least one stretching direction of less than or equal to 180%,
providing a carrier layer of paper with a grammage of about 40 to 120 g/m² is provided,
applying a connecting layer to at least one of the barrier film and the carrier layer, and
connecting the barrier film with the carrier layer via the connecting layer.

15. The packaging laminate according to claim 1, wherein the barrier film has a layer thickness of less than 5 μm.

16. The packaging laminate according to claim 1, wherein the elongation at break of the barrier film in the at least one stretching direction is less than or equal to 130%.

17. The packaging laminate according to claim 3, wherein the first elongation at break of the barrier film in the first stretching direction is less than or equal to 130%,

18. The packaging laminate according to claim 3, wherein the second elongation at break of the barrier film in the second stretching direction is less than or equal to 130%.

19. The packaging laminate according to claim 6, wherein the metallization comprises aluminum.
